(19) United States
(12) Patent Application Publication
(10) Pub. No.: US 2024/0177057 A1
(43) Pub. Date: May 30, 2024

(54) FEDERATED LEARNING METHOD AND APPARATUS, ELECTRONIC DEVICE, AND STORAGE MEDIUM

(71) Applicant: JINGDONG TECHNOLOGY HOLDING CO., LTD., Beijing (CN)

(72) Inventors: Wenxi ZHANG, Beijing (CN); Peiqi WANG, Beijing (CN); Songxiang GU, Beijing (CN)

(21) Appl. No.: 18/283,524

(22) PCT Filed: Apr. 2, 2022
(86) PCT No.: PCT/CN2022/085188

§ 371 Date: Sep. 22, 2023

(30) Foreign Application Priority Data
Apr. 9, 2021 (CN) 202110382357.0

(51) Int. Cl. G06N 20/00

(52) U.S. Cl. CPC G06N 20/00

(57) ABSTRACT

A federated learning training method is performed by a server. The method comprises: receiving gradient information of a labeled sample of each client sent by each client; according to the gradient information sent by each client, obtaining target gradient information belonging to a same labeled sample; determining a client to which each labeled sample belongs; and sending, to a client to which the same labeled sample belongs, the target gradient information corresponding to the same labeled sample.

### CROSS-REFERENCE TO RELATED APPLICATIONS

This application is the U.S. national phase application of International Application No. PCT/CN2022/085188, filed on Apr. 2, 2022, which is based on and claims priority to Chinese Patent Application No. 202110382357.0, filed on Apr. 9, 2021, the entire contents of which are incorporated herein by reference.

### TECHNICAL FIELD

The disclosure relates to a field of data statistical analysis, and particularly to a federated learning method, an electronic device and a storage medium.

### BACKGROUND

In a process of training a machine learning model, labeled data of a sample may be used for calculating a gradient, a node splitting gain and other numerical values.

### SUMMARY

A federated learning-based training method is proposed in a first aspect of the disclosure, which is performed by a server. The method includes: receiving gradient information of a labeled sample sent by each client; obtaining, based on the gradient information sent by each client, target gradient information belonging to a same labeled sample; determining a client to which each labeled sample belongs; and sending the target gradient information corresponding to the same labeled sample to a client to which the same labeled sample belongs.

Another federated learning-based training method is further proposed in a second aspect of the disclosure, which is performed by a client. The method includes: sending gradient information of a labeled sample of the client to a server after each training; receiving target gradient information of each labeled sample belonging to the client sent by the server; and obtaining a target federated learning model by updating, based on the target gradient information, a model parameter of a local learning model and performing a next training.

An electronic device is proposed in a third aspect of the disclosure, and includes: at least one processor; and a memory communicatively connected to the at least one processor and stored with instructions executable by the at least one processor. When the instructions are executed by the at least one processor, the at least one processor is caused to perform the federated learning-based training method according to the second aspect.

It should be understood that, the content described in the disclosure is not intended to recognize key or important features of the embodiments of the disclosure, nor intended to limit the scope of the disclosure. Other features of the disclosure may be easy to understand through the following specification.

### BRIEF DESCRIPTION OF THE DRAWINGS

The above and/or additional aspects and advantages of the disclosure may become obvious and easy to understand from the following description of the embodiments in conjunction with the accompanying drawings.

FIG. 1 is a flowchart illustrating a federated learning-based training method according to an embodiment of the disclosure.

FIG. 2 is a flowchart illustrating a federated learning-based training method according to another embodiment of the disclosure.

FIG. 3 is a flowchart illustrating a federated learning-based training method according to yet another embodiment of the disclosure.

FIG. 4 is a flowchart illustrating a federated learning-based training method according to yet another embodiment of the disclosure.

FIG. 5 is a flowchart illustrating a federated learning-based training method according to yet another embodiment of the disclosure.

FIG. 6 is a flowchart illustrating a federated learning-based training method according to yet another embodiment of the disclosure.

FIG. 7 is a flowchart illustrating a federated learning-based training method according to yet another embodiment of the disclosure.

FIG. 8 is a flowchart illustrating a federated learning-based training method according to yet another embodiment of the disclosure.

FIG. 9 is a flowchart illustrating a federated learning-based training method according to yet another embodiment of the disclosure.

FIG. 10 is a flowchart illustrating a federated learning-based training method according to yet another embodiment of the disclosure.

FIG. 11 is a diagram illustrating a structure of a federated learning-based training apparatus according to an embodiment of the disclosure.

FIG. 12 is a diagram illustrating a structure of a federated learning-based training apparatus according to another embodiment of the disclosure.

FIG. 13 is a diagram illustrating a structure of a federated learning-based training apparatus according to yet another embodiment of the disclosure.

FIG. 14 is a diagram illustrating a structure of a federated learning-based training apparatus according to yet another embodiment of the disclosure.

FIG. 15 is a diagram illustrating a structure of an electronic device in an embodiment of the disclosure.

### DETAILED DESCRIPTION

The embodiments of the disclosure are described in detail below. Examples of the embodiments are shown in the accompanying drawing, throughout which the same or similar labels indicate the same or similar components or components with the same or similar functions. The embodiments described below with reference to the accompanying drawings are exemplary, and are intended to explain the disclosure, but should not be understood as a limitation to the disclosure.

In the related art, local data used by a machine learning algorithm-based training process may be distributed on a plurality of platforms, and data transmission between a platform and a platform cannot be achieved. Therefore, when sample data with the same label is existed in plurality of platforms, it may be defined that such sample data with the same label is only remained in a specified platform while sample data with the same label on other platforms may be discarded, which results in a relatively high discard rate of the sample data, so that when a part of sample labels are wrongly marked, sample data with the same label on the other platforms cannot be utilized to achieve effective correction, thus resulting in an influence on the accuracy of model training to a certain extent.

In view of the above problem, a federated learning-based training method and a federated learning-based training apparatus, an electronic device and a storage medium are described with reference to the accompanying drawings in the embodiments of the disclosure.

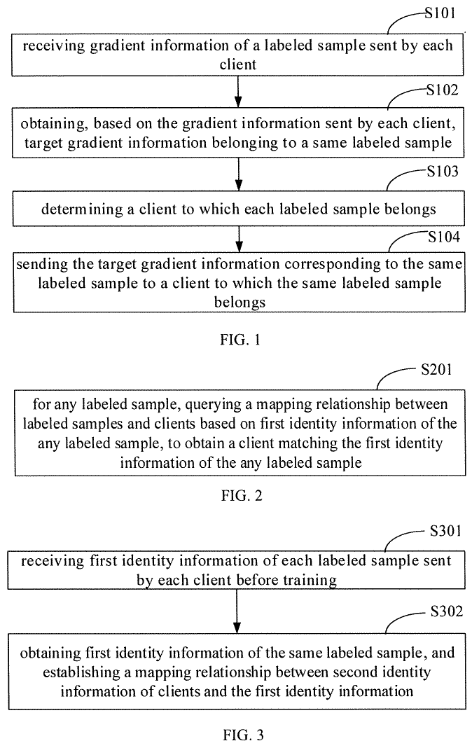

FIG. 1 is a flowchart illustrating a federated learning-based training method according to an embodiment of the disclosure. The method is executed by a server. As illustrated in FIG. 1, the method includes steps at S101 to S104.

At S101, gradient information of a labeled sample sent by each client is received.

The federated learning (FL) is directed to a machine learning algorithm, of which samples are distributed on a plurality of clients, and the sample data cannot be sent out of the local. In the implementation, a plurality of clients may participate in the FL-based training, and each of the plurality of clients has its local sample data.

It should be noted that, the local sample data of the client may be labeled sample data, or may be unlabeled sample data.

The sample data of the same object may exist in a plurality of clients. Further, the sample data of the same object on different clients may be same or different. For example, assuming that the object X may have two different sample data, i.e., static information and dynamic information, static information samples such as name and age may exist in the client A, and at the same time, the static information samples such as name and age may also exist in the client B. In addition, dynamic information samples such as online shopping records and search records may exist in the client C, and at the same time, the dynamic information samples such as online shopping records and search records may also exist in the client B. It may be understood that the sample data of the same object may be randomly distributed on different clients.

In the related art, a FL-based training process may be performed by a specified client to calculate data of a sample, such as gradient information and a splitting gain. In a training scenario based on vertical FL and/or horizontal FL, for the same labeled sample in a plurality of clients during the training, only the labeled sample in the specified client may be reserved while the same labeled samples in other non-specified clients may be discarded so that they do not participate in the training, leading to a high sample discard rate. Meanwhile, since the same labeled samples in other non-specified clients cannot be used for training, a model training effect of the same labeled sample on the specified client cannot be corrected, resulting in an inaccurate model training result.

In the embodiments of the disclosure, the client may send the obtained gradient information of the labeled sample to the server, and the server may receive the gradient information of the labeled sample sent by each client. The gradient information is configured to adjust the federated learning model for performing a next training. In some embodiments, the gradient information includes a first-order gradient gᵢ and a second-order gradient hᵢ generated when a loss function of a model is calculated.

At S102, target gradient information belonging to a same labeled sample is obtained based on the gradient information sent by each client.

After obtaining the gradient information of the labeled sample sent by each client, the server determines clients to which the same labeled sample belongs based on the obtained gradient information, and further determines one or more pieces of gradient information corresponding to the same labeled sample. A number of the pieces of gradient information is determined by a number of clients to which the same labeled sample belongs. When the number of clients to which the same labeled sample belongs is greater than 1, the number of the pieces of gradient information corresponding to the same labeled sample is greater than 1. When the number of clients to which the same labeled sample belongs is 1, the number of the pieces of gradient information corresponding to the same labeled sample is 1.

In the embodiments of the disclosure, after obtaining one or more pieces of gradient information corresponding to the same label sample, the server performs a fusion calculation on the obtained pieces of gradient information to obtain the target gradient information corresponding to the same labeled sample.

The fusion calculation may be addition and averaging, or may be weighted processing.

For example, for the same labeled sample X, assuming that the clients corresponding to the current FL-based training includes the clients A˜N. The same labeled sample X exists in M clients among the clients A˜N, and the M clients send gradient information of their own same labeled sample X to a server. The server may obtain a plurality of pieces of gradient information of the same labeled sample X sent by the M clients, and perform a fusion calculation based on the obtained pieces of gradient information, to obtain target gradient information corresponding to the same labeled sample X.

In some embodiments, the plurality of pieces of gradient information of the same labeled sample X sent by the M clients may be added to obtain a sum value and the sum value is averaged to obtain the target gradient information. Alternatively, the plurality of pieces of gradient information of the same labeled sample X may be weighted with the corresponding weight values of the M clients to which the same labeled sample X belongs, so as to obtain the target gradient information.

At S103, a client to which each labeled sample belongs is determined.

The clients may send the gradient information of their labeled samples to the server. After the server obtains target gradient information of the labeled sample, the server may recognize and determine a client to which the labeled sample belongs based on a transmission source for the target gradient information.

In some embodiments, a client to which a labeled sample belongs may be recognized based on a website of the client, since different clients may have different websites. Before model training begins, the client may send its website information and its corresponding client information to the server, and the server may construct a mapping relationship based on the obtained website information and the corresponding client information. In the model training, the server queries the mapping relationship based on a website used for transmitting gradient information of a labeled sample to determine a client to which the labeled sample belongs.

In some embodiments, before the model training begins, the client may set its identity information, and an identity of each client is unique and not repeated. In the model training, when the client sends gradient information of its labeled sample, the identity set by the client may be simultaneously sent to the server. The server may recognize client identity information included in information sent by a client, and query a mapping relationship based on the obtained identity to determine a client to which the labeled sample belongs.

At S104, the target gradient information corresponding to the same labeled sample is sent to a client to which the same labeled sample belongs.

In the embodiments of the disclosure, after the server determines a client to which a labeled sample belongs, the server may send the obtained target gradient information of the same labeled sample to the corresponding client.

After the server determines a client to which each labeled sample belongs, the server may send the obtained target gradient information corresponding to the same labeled sample to the corresponding client.

According to the FL-based training method in the disclosure, the server obtains gradient information of the labeled sample sent by each client, obtains target gradient information corresponding to the same labeled sample, recognizes the client to which each labeled sample belongs, and sends the corresponding target gradient information to a client to which the same labeled sample belongs. In the disclosure, gradient information of labeled samples of a plurality of clients is used as basic sample data for FL-based training, and same labeled samples existing in the plurality of clients are not discarded. Furthermore, fusion calculation and updating of the gradient information of the same labeled samples existing in the plurality of clients are performed, to achieve effective correction of a model training deviation, and further improve the accuracy of model training.

It may be further understood that the client to which the labeled sample belongs may be determined in the above embodiments in combination with FIG. 2. FIG. 2 is a flowchart illustrating a FL-based training method according to another embodiment of the disclosure. The method is executed by a server. As illustrated in FIG. 2, the method includes at S201. That is, for any labeled sample, a mapping relationship between labeled samples and clients is queried based on first identity information of the any labeled sample, to obtain a client matching the first identity information of the any labeled sample.

When the client sends the labeled sample to the server, the labeled sample may carry a plurality of pieces of identity information, and the identity information may include unique and non-repeated information that identifies its corresponding labeled sample, which may be used as first identity information.

There is a mapping relationship between first identity information of a labeled sample and the client to which the labeled sample belongs, and the mapping relationship may be stored at a set position of the server before model training begins.

In the embodiments of the disclosure, after obtaining the first identity information of the labeled sample, the server queries the mapping relationship prestored at the set position by using the first identity information as a query condition, further to obtain a client matching the first identity information of the labeled sample.

The same labeled sample may exist in one or more clients, so that there may be one or more client corresponding to the first identity information of the same labeled sample.

For example, the first identity information of any labeled sample A is set to be N, and in the mapping relationship prestored by the server, clients corresponding to the first identity information N are the client M, the client S and the client Q. The server recognizes the first identity information N carried in the labeled sample A after obtaining the labeled sample A, and query the mapping relationship prestored at a set position by taking the first identity information N as a query condition, and it may be further determined that the clients to which the labeled sample A belongs are the client M, the client S and the client Q.

According to the FL-based method in the disclosure, a method for obtaining the client to which the labeled sample belongs is defined, so that the server may accurately obtain the client to which the labeled sample belongs based on the first identity information, thereby ensuring the accuracy of subsequent information transmission, and further ensuring the accuracy of model training.

The mapping relationship between pieces of first identity information and clients in the above embodiment may be further understood in combination with FIG. 3. FIG. 3 is a flowchart illustrating a FL-based training method according to another embodiment of the disclosure. The method is executed by a server. As illustrated in FIG. 3, the method includes steps at S301 to S302.

At S301, first identity information of the labeled sample sent by each client before training is received.

The client needs to send the first identity information of the labeled sample of the client itself to the server before the model training begins. The server may receive the first identity information of the labeled sample sent by each client. The first identity information may represent a corresponding labeled sample.

It should be noted that settings of the first identity information of the labeled samples of all clients participating in the FL-based training follow a uniform rule.

At S302, first identity information of the same labeled sample is obtained, and a mapping relationship between second identity information of clients and the first identity information is established.

In the embodiments of the disclosure, the client may use unique and non-repeated information in attribute information as second identity information, and the second identity information may represent a client. The client registers its corresponding second identity information at a server side before the model training begins.

It should be noted that settings of the second identity information of all clients participating in the FL-based training follow a uniform rule.

After the server obtains the first identity information sent by the client, the server establishes a mapping relationship between the first identity information of the labeled sample and the second identity information of the client based on the first identity information and the corresponding second identity information.

The first identity information of the labeled sample may only correspond to second identity information of a certain client, or may correspond to second identity information of a plurality of clients.

For example, first identity information of a certain labeled sample is α, and the clients that register their local labeled samples in the server including the first identity information α are β, γ, θ Then, the second identity information that may construct a mapping relationship with the first identity information α includes β, γ, θ.

For another example, first identity information of a certain labeled sample is N, and there is only a client M that registers its local labeled sample in the server including the first identity information N. Then, the second identity information that may construct a mapping relationship with the first identity information N is only M.

Based on the above examples, the server may construct a mapping relationship table as illustrated in Table 1:

TABLE 1
a mapping relationship between first identity information of
a labeled sample and second identity information of a client

| First Identity Information | Second Identity Information |
|---|---|
| α | β, γ, θ |
| N | M |
| . . . | . . . |

According to the FL-based training method in the disclosure, an establishment process of a mapping relationship between first identity information of a labeled sample and second identity information of a client is defined, which ensures the accuracy of the mapping relationship, so that subsequent information may be accurately transmitted, the accuracy of model training may also be ensured.

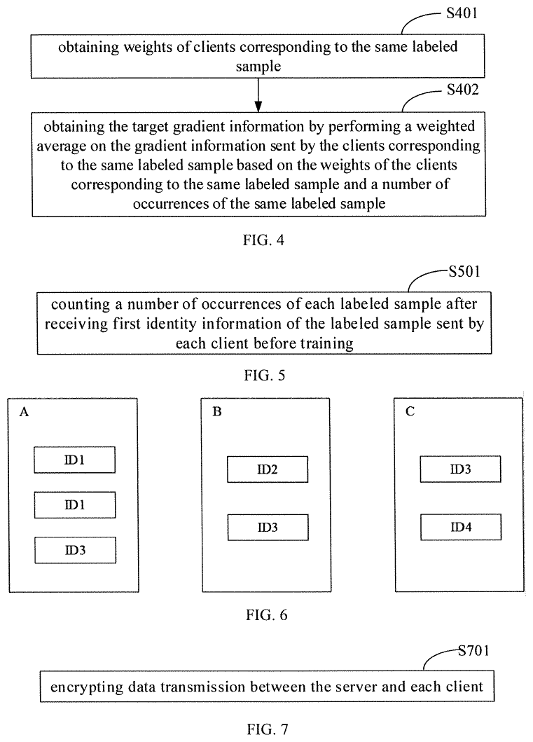

Obtaining the target gradient information according to the above embodiment may be further understood in combination with FIG. 4. FIG. 4 is a flowchart illustrating a FL-based training method according to another embodiment of the disclosure. The method is executed by a server. As illustrated in FIG. 4, the method includes steps at S401 to S402.

At S401, weights of clients corresponding to the same labeled sample are obtained.

The server may preset the weights of clients participating in FL-based training before the model training begins. The weight value may be configured based on related factors such as a role identity of a client in the FL-based training, an attribute of the client and occurrence of a data preprocessing abnormal value.

For example, when the availability of a labeled sample obtained by a client is high, a high weight value may be set for the client, so that the labeled sample of the client may be fully utilized in the model training.

For another example, when a client is a user of a target model generated by FL-based training, a high weight value may be set for the client, so that the finally generated model is more adapted to the client.

For another example, the clients participating in the FL-based training may be set with the same weight value, so that the labeled samples on respective clients may be effectively utilized.

In the embodiments of the disclosure, before the model training begins, the user stores a self-set weight value of each client participating in FL-based training into a server. In the FL-based training, the server recognizes the client corresponding to the same labeled sample, based on the obtained gradient information of the labeled sample sent by the client, and queries a pre-stored weight value, so as to obtain the weights of the clients corresponding to the same labeled sample.

At S402, the target gradient information is obtained by performing a weighted average on the gradient information sent by the clients corresponding to the same labeled sample, based on the weights of the clients corresponding to the same labeled sample and a number of occurrences of the same labeled sample.

In the embodiments of the disclosure, after obtaining the labeled sample sent by the client, the server counts a number of occurrences of the same labeled sample, and performs a fusion calculation on all gradient information of the same labeled sample based on the counted number of occurrences and the obtained weights of the clients corresponding to the same labeled sample, to obtain target gradient information. The fusion calculation may be weighted averaging.

For example, assuming that the gradient information of the same label sample sent by the client to the server is a first-order gradient gᵢ, the counted number of occurrences for gᵢ is nᵢ, and the weight of the client corresponding to the same labeled sample is w_{i,j}, then the server may perform an operation based on an equation to obtain corresponding target gradient information gᵢ(j), and the equation is as follows:

$${g}_{i} = \frac{1}{{n}_{i}} \cdot {\sum }_{j = 1}^{{n}_{i}} ( {w}_{i , j} \cdot {g}_{i} ( j ) )$$

For another example, assuming that the gradient information of the same label sample sent by the client to the server is a second-order gradient hᵢ, and the counted number of occurrences for hᵢ is nᵢ and the weight of the client corresponding to the same labeled sample is w_{i,j}, then the server may perform an operation based on an equation to obtain corresponding target gradient information hᵢ(j), and the equation is as follows:

$${h}_{i} = \frac{1}{{n}_{i}} \cdot {\sum }_{j = 1}^{{n}_{i}} ( {w}_{i , j} \cdot {h}_{i} ( j ) )$$

According to the FL-based training method in the disclosure, a method for calculating target gradient information of the same labeled sample is defined, so that the accuracy of the target gradient information is guaranteed, the client gradient information in each round of training may be accurately updated, and the accuracy of model training may be ensured.

As described in the above embodiments, a counting process of a number of occurrences of the same labeled sample may be further understood in combination with FIG. 5. FIG. 5 is a flowchart illustrating a FL-based training method according to another embodiment of the disclosure. The method is executed by a server. As illustrated in FIG. 5, the method includes S501, at which a number of occurrences of each labeled sample is counted after receiving first identity information of the labeled sample sent by each client before training.

In the embodiments of the disclosure, the server may obtain first identity information of the labeled sample sent by the client, may count a number of occurrences of each labeled sample based on the obtained first identity information of each labeled sample, and may set a record format. The server records the counted numbers based on a set format and stores them in the form of a table.

For example, the record format of a number of occurrences of a labeled sample may be <ID_i, n_i>, where ID_i represents first identity information corresponding to a labeled sample, and n_i represents a number of occurrences of the first identity information corresponding to the labeled sample. As illustrated in FIG. 6, there are three clients, which are the client A, the client B and the client C, respectively. According to the situation of labeled samples existed in the three clients, it can be seen that a number of occurrences of first identity information ID1 is 2, and may be recorded as <ID_1,2>, a number of occurrences of first identity information ID2 is 1 and may be recorded as <ID_2,1>, a number of occurrences of first identity information ID3 is 3 and may be recorded as <ID_3,3>, and a number of occurrences of first identity information ID4 is 1 and may be recorded as <ID_4,1>. The number of occurrences of the corresponding labeled sample may be determined based on the recorded number of occurrences of the first identity information.

According to the FL-based training method in the disclosure, the counting process of the number of occurrences of the labeled sample is illustrated, which provides the accurate and efficient counting number of times for subsequent calculation of the target gradient information, and ensures the accuracy of model training.

FIG. 7 is a flowchart illustrating a FL-based training method according to another embodiment of the disclosure. The method is executed by a server. As illustrated in FIG. 7, the method includes S701, at which data transmission between the server and each client is encrypted.

To ensure the security and confidentiality of sample data used in the model training, the data transmission between the client and the server needs to be encrypted.

In some embodiments, a common encryption solution may be used. Before the model training begins, the server may generate a pair of keys including a public key and a private key, and send the public key to each client. When the client transmits related information such as gradient information of a labeled sample and first identity information, the client encrypts the related information by using the public key first and transmits the encrypted information to the server. The server decrypts the encrypted information by using the private key, and calculates the target gradient information.

According to the encryption solution, data between respective clients may be kept confidential.

In some embodiments, a homomorphic encryption solution may be used. Each client determines a pair of homomorphic encrypted keys including a public key and a private key before the model training begins, and sends the public key to the server. When the client transmits related information such as gradient information of a labeled sample and first identity information, the client may encrypt the related information by using the public key. The server performs a ciphertext calculation by using the public key after obtaining the encrypted information, to obtain the encrypted target gradient information, and transmits the encrypted target gradient information to each corresponding client. The client decrypts the encrypted target gradient information by using the private key after obtaining the encrypted target gradient information, and updates the gradient information on the client itself based on the decrypted target gradient information.

According to the encryption solution, data confidentiality between the client and the server may be achieved.

According to the FL-based training method in the disclosure, different data encryption solutions are provided based on the model training, which improves the confidentiality of data transmission and ensures data security in a model training process.

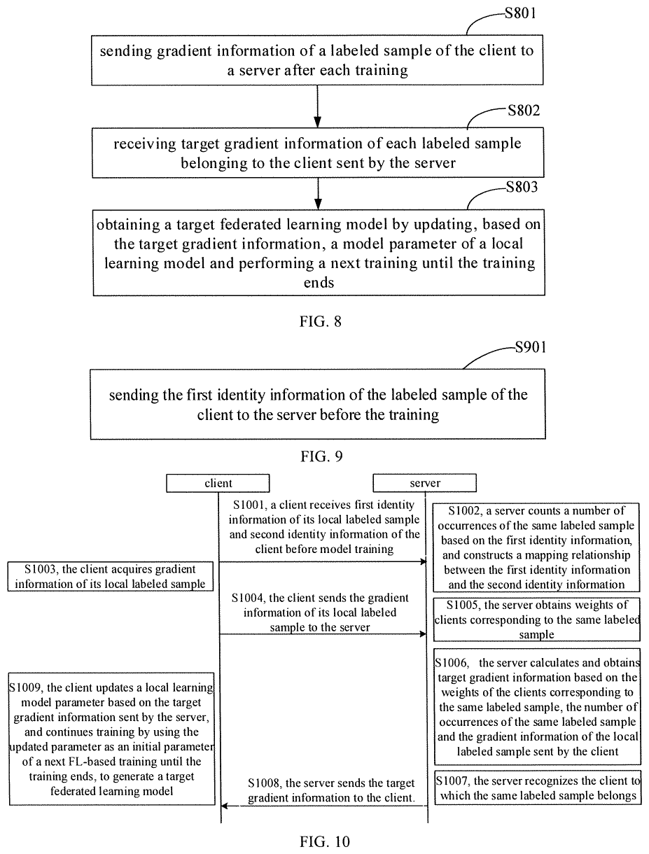

To achieve the FL-based training method according to the above embodiments, another FL-based training method is proposed in the disclosure. FIG. 8 is a flowchart illustrating a FL-based training method according to an embodiment of the disclosure. The method is executed by a client. As illustrated in FIG. 8, the method includes steps at S801 to S803.

At S801, gradient information of a labeled sample of the client is sent to a server after each training ends.

In the embodiments of the disclosure, after each training ends, the client needs to send the gradient information of its local labeled sample generated during the training to the server.

Further, after the server obtains the gradient information of the local labeled sample sent by the client, the server recognizes the client to which the same labeled sample belongs, to determine weights of the clients corresponding to the same labeled sample, and counts a number of occurrences of the same label sample. Further, the server calculates and generates target gradient information corresponding to the same label sample in combination with the obtained gradient information corresponding to the labeled sample sent by the client, and returns the target gradient information to the client.

At S802, target gradient information of each labeled sample belonging to the client sent by the server is received.

In the embodiments of the disclosure, the server sends the target gradient information corresponding to the labeled sample to the client, and the client may receive the target gradient information corresponding to the local labeled sample of the client itself, in which each labeled sample has corresponding target gradient information.

At S803, a target federated learning model is obtained by updating, based on the target gradient information, a model parameter of a local federated learning model and performing a next training until the training ends.

In the embodiments of the disclosure, the client may obtain the target gradient information corresponding to the labeled sample sent by the server, and update a model parameter of a local learning module based on the target gradient information. When the model parameter of the local learning module is updated, a next FL-based training may be continued until an end condition of the FL-based training is met and the training ends. Then, the federated learning model generated by the current training may be used as a final target federated learning model.

In some embodiments, the end condition of the FL-based training may be a number of trainings. Before the model training begins, the number of FL-based trainings may be preset. After each FL-based training is completed, it is recognized whether the number of FL-based trainings completed at the current time reaches the preset number of trainings, to determine whether the FL-based training meets the end condition.

In some embodiments, the end condition of the FL-based training may be an effect of the federated learning model. An effect parameter expected to be met by the federated learning model may be preset before the model training begins. After each FL-based training is completed, it is recognized whether the effect parameter of the federated learning model output by the FL-based training completed at the current time reaches the preset effect parameter, to determine whether the FL-based training meets the end condition.

According to the FL-based training method in the disclosure, the client sends the gradient information of the labeled sample to the server, and receives the target gradient information corresponding to the same labeled sample returned by the server, updates the model parameter of the local learning model based on the obtained target gradient information, and continues the training by using the updated model parameter as an initial parameter of the next training, until the training ends, thereby generating a target federated learning model. In the disclosure, the client sends the gradient information of the labeled sample to the server, which provides a sample data basis for each time of the model training, and ensures that the model training is effectively achieved.

FIG. 9 is a flowchart illustrating a FL-based training method according to another embodiment of the disclosure. The method is executed by a client. As illustrated in FIG. 9, the method includes S901, at which the first identity information of the labeled sample of the client is sent to the server before the training begins.

In the embodiments of the disclosure, in order to ensure that the client may accurately recognize the client to which the labeled sample belongs, the client needs to send the first identity information of its local labeled sample to the server before the model training begins. The server may construct in advance a mapping relationship between the first identity information and the second identity information.

According to the FL-based training method in the disclosure, a sending time of the first identity information is defined, so that the construction of the mapping relationship between the first identity information and the second identity information may be completed before the model training begins, thereby ensuring that a subsequent model training may be smoothly performed.

As an implementation, data transmission between the client and the server is encrypted.

In order to ensure the data security of the client, data transmitted between the client and the server is encrypted. The specific encryption solution may refer to the above detailed content, which is not described herein.

According to the FL-based training method in the disclosure, different data encryption solutions are provided based on the model training, which improves the confidentiality of data transmission and ensures the data security in a model training process.

To understand the FL-based training method according to the above embodiment better, FIG. 10 is a flowchart illustrating a FL-based training method according to another embodiment of the disclosure. As illustrated in FIG. 10, the method includes steps at S1001 to S1009.

At S1001, a client receives first identity information of its local labeled sample and second identity information of the client before model training.

At S1002, a server counts a number of occurrences of the same labeled sample based on the first identity information, and constructs a mapping relationship between the first identity information and the second identity information.

At S1003, the client obtains gradient information of its local labeled sample.

At S1004, the client sends the gradient information of its local labeled sample to the server.

At S1005, the server obtains weights of clients corresponding to the same labeled sample.

At S1006, the server calculates and obtains target gradient information based on the weights of the clients corresponding to the same labeled sample, the number of occurrences of the same labeled sample and the gradient information of the local labeled sample sent by the client.

At S1007, the server recognizes the client to which the same labeled sample belongs.

At S1008, the server sends the target gradient information to the client.

At S1009, the client updates a local learning model parameter based on the target gradient information sent by the server, and continues training by using the updated parameter as an initial parameter of a next FL-based training until the training ends, to generate a target federated learning model.

In the embodiments of the disclosure, the client sends the first identity information of the labeled sample and the second identity information of the client to the server before the model training begins, so that the server constructs a mapping relationship between the first identity information and the second identity information based on the obtained first identity information and the second identity information, and counts the number of occurrences of the same labeled sample based on the first identity information. The client calculates and sends the gradient information of the local labeled sample to the server, so that the server obtains the weights of the clients corresponding to the same labeled sample based on the obtained gradient information of the labeled sample sent by the client. Further, the server calculates and obtains the target gradient information corresponding to the same labeled sample based on the obtained gradient information of the same labeled sample, the weights of the clients corresponding to the same labeled sample and the corresponding number of occurrences of the same labeled sample, recognizes the client to which the same labeled sample belongs, and sends the target gradient information to the corresponding client. The client updates the local learning model parameter based on the obtained target gradient information sent by the server, and continues training by using the updated parameter as an initial parameter of the next FL-based training until the training ends, further to generate the target federated learning model.

It should be noted that the information transmission between the server and the client is performed in an encrypted state.

In the disclosure, gradient information of labeled samples of a plurality of clients is used as basic sample data for FL-based training, and same labeled samples existing in the plurality of clients are not discarded. Furthermore, fusion calculation and updating of the gradient information of the same labeled samples existing in the plurality of clients are performed, to achieve effective correction of a model training deviation, and further improve the accuracy of model training. Further, data transmission between the server and the client is encrypted to achieve the data confidentiality.

Corresponding to the FL-based training method according to the above embodiments, a FL-based training apparatus is further proposed in an embodiment of the disclosure. Since the training apparatus according to the embodiment corresponds to the training method according to the above embodiments, the implementation of the training method is also applicable to the training apparatus according to the embodiment, which may not be described below.

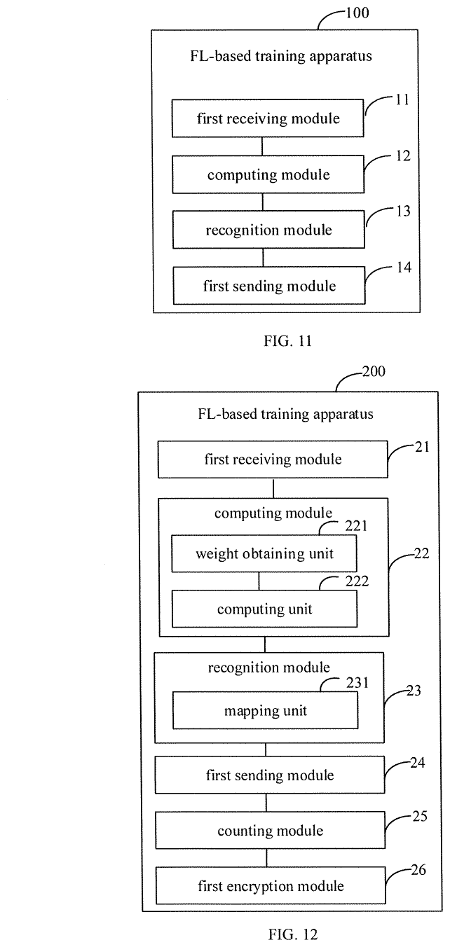

To achieve the FL-based training method according to the above embodiment, a FL-based training apparatus is proposed in the disclosure. FIG. 11 is a diagram illustrating a structure of a FL-based training apparatus w according to an embodiment of the disclosure. The apparatus is deployed on a server. As illustrated in FIG. 11, the FL-based training apparatus 100 includes a first receiving module 11, a computing module 12, a recognition module 13 and a first sending module 14.

The first receiving module 11 is configured to receive gradient information of a labeled sample sent by each client.

The computing module 12 is configured to obtain, based on the gradient information sent by each client, target gradient information belonging to a same labeled sample.

The recognition module 13 is configured to determine a client to which each labeled sample belongs.

The first sending module 14 is configured to send the target gradient information corresponding to the same labeled sample to a client to which the same labeled sample belongs.

According to the FL-based training apparatus in the disclosure, the server obtains gradient information of the labeled sample sent by the client, performs calculation based on a preset rule to obtain target gradient information belonging to the same labeled sample, recognizes the client to which each labeled sample belongs, and sends the corresponding target gradient information to a client to which the same labeled sample belongs. In the disclosure, gradient information of labeled samples of a plurality of clients is used as basic sample data for FL-based training, and same labeled samples existing in the plurality of clients are not discarded. Furthermore, fusion calculation and updating of the gradient information of the same labeled samples existing in the plurality of clients are performed, to achieve effective correction of a model training deviation, and further improve the accuracy of model training.

FIG. 12 is a diagram illustrating a structure of a FL-based training apparatus according to another embodiment of the disclosure. The apparatus is deployed on a server. As illustrated in FIG. 12, the FL-based training apparatus 200 includes a first receiving module 21, a computing module 22, a recognition module 23, a first sending module 24, a counting module 25 and a first encryption module 26.

It should be noted that, the first receiving module 11, the computing module 12, the recognition module 13 and the first sending module 14 have the same function and structure with the first receiving module 21, the computing module 22, the recognition module 23 and the first sending module 24.

In the embodiments of the disclosure, the recognition module 23 includes a mapping unit 231, configured to, for any labeled sample, query a mapping relationship between labeled samples and clients based on first identity information of the any labeled sample, to obtain a client matching the first identity information of the any labeled sample.

In the embodiments of the disclosure, the first generating module 21 is further configured to: receive first identity information of the labeled sample sent by each client before training; and obtain first identity information of the same labeled sample, and establish a mapping relationship between second identity information of clients and the first identity information.

In the embodiments of the disclosure, the computing module 22 includes a weight obtaining unit 221 and a computing unit 222.

The weight obtaining unit 221 is configured to obtain weights of clients corresponding to the same labeled sample.

The computing unit 222 is configured to obtain the target gradient information by performing a weighted average on the gradient information sent by the clients corresponding to the same labeled sample based on the weights of the clients corresponding to the same labeled sample and a number of occurrences of the same labeled sample.

In the embodiments of the disclosure, the FL-based training apparatus 200 further includes a counting module 25. The counting module 25 is configured to count a number of occurrences of each labeled sample after receiving first identity information of the labeled sample sent by each client before training.

In the embodiments of the disclosure, the FL-based training apparatus 200 further includes a first encryption module 26. The first encryption module 26 is configured to encrypt data transmission between the server and the client.

According to the FL-based training apparatus in the disclosure, the server constructs a mapping relationship between the first identity information and the second identity information of the client sent by the client, and counts a corresponding number of occurrences of the labeled sample. The server obtains weights of clients corresponding to the same labeled sample based on the obtained gradient information of the local labeled sample sent by the client. Further, the server calculates and obtains the corresponding target gradient information based on the gradient information, the number of occurrences and the weights of the clients of the same labeled sample, and sends the target gradient information to the recognized client to which the same labeled sample belongs. In the disclosure, gradient information of labeled samples of a plurality of clients is used as basic sample data for FL-based training, and same labeled samples existing in the plurality of clients are not discarded. Furthermore, fusion calculation and updating of the gradient information of the same labeled samples existing in the plurality of clients are performed, to achieve effective correction of a model training deviation, and further improve the accuracy of model training. Further, data transmission between the server and the client is encrypted to achieve data confidentiality.

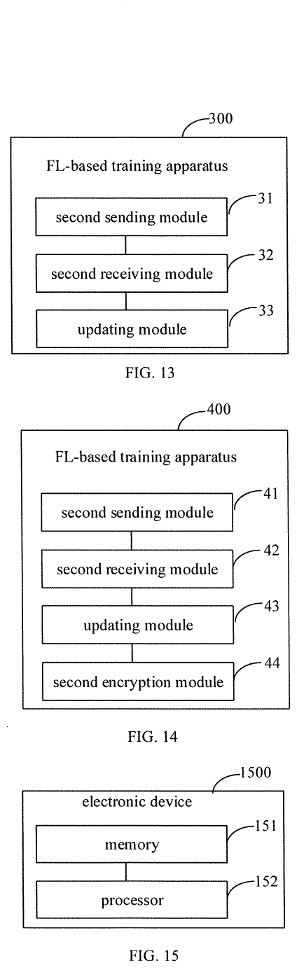

To achieve the FL-based training method according to the above embodiment, a FL-based training apparatus is proposed in the disclosure. FIG. 13 is a diagram illustrating a structure of a FL-based training apparatus according to another embodiment of the disclosure. The apparatus is deployed on a client. As illustrated in FIG. 13, the FL-based training apparatus includes a second sending module 31, a second receiving module 32 and an updating module 33.

The second sending module 31 is configured to send gradient information of a labeled sample of the client to a server after each training ends.

The second receiving module 32 is configured to receive target gradient information of each labeled sample belonging to the client sent by the server.

The updating module 33 is configured to obtain a target federated learning model by updating, based on the target gradient information, a model parameter of a local learning model and performing a next training until the training ends.

According to the FL-based training apparatus in the disclosure, the client sends the gradient information of the labeled sample to the server, and receives the target gradient information corresponding to the labeled sample returned by the server, updates the model parameter of the local learning model based on the obtained target gradient information, and continues training by using the updated model parameter as an initial parameter of a next round of training until the training ends, to generate a target federated learning model. In the disclosure, the client sends the gradient information of the labeled sample to the server, which provides a sample data basis for each training in the model training, and ensures that the model training is effectively achieved.

FIG. 14 is a diagram illustrating a structure of a FL-based training apparatus according to another embodiment of the disclosure. The apparatus is deployed on a client. As illustrated in FIG. 14, the FL-based training apparatus 400 includes a second sending module 41, a second receiving module 42, an updating module 43 and a second encryption module 44.

It should be noted that, the second sending module 31, the second receiving module 32 and the updating module 33 have the same function and structure with the second sending module 41, the second receiving module 42 and the updating module 43.

In the embodiments of the disclosure, the second sending module 41 is further configured to: send first identity information of the labeled sample of the client to the server before the training begins.

In the embodiments of the disclosure, the FL-based training apparatus 400 further includes a second encryption module 44. The second encryption module 44 is configured to encrypt data transmission between the server and the client.

According to the FL-based training apparatus in the disclosure, the client sends the first identity information of the labeled sample and the second identity information of the client to the server before the model training begins, and the client calculates the gradient information of its local labeled sample, and sends the gradient information of its local labeled sample to the server after the model training begins. Further, the model parameter of the local learning model is updated based on the obtained target gradient information corresponding to the labeled sample that is calculated and returned by the server, and training is continued by using the updated model parameter as an initial parameter of the next training, thereby generating a target federated learning model. In the disclosure, gradient information of labeled samples of a plurality of clients is used as basic sample data for FL-based training, and same labeled samples existing in the plurality of clients are not discarded, and fusion calculation and updating of the gradient information of the same labeled samples existing in the plurality of clients are performed, to achieve effective correction of a model training deviation, and further improve the accuracy of model training. Further, data transmission between the server and the client is encrypted to achieve data confidentiality.

To achieve the above embodiments, an electronic device, a computer-readable storage medium and a computer program product are further proposed according to the embodiments of the disclosure.

FIG. 15 is an example block diagram illustrating an example electronic device 1500 in the embodiment of the disclosure. The electronic device is intended to represent various types of digital computers, such as laptop computers, desktop computers, workstations, personal digital assistants, servers, blade servers, mainframe computers, and other suitable computers. The electronic device may also represent various types of mobile devices, such as personal digital assistants, cellular phones, smart phones, wearable devices, and other similar computing devices. The components shown herein, their connections and relations, and their functions are merely examples, and are not intended to limit the implementation of the disclosure described and/or required herein.

As illustrated in FIG. 15, the electronic device 1500 includes a memory 151, a processor 152 and a computer program stored on the memory 151 and executable by the processor 152. When the program is executed by the processor, the FL-based training method is implemented.

According to the electronic device in the embodiments of the disclosure, the computer program stored on the memory 151 is executed by the processor 152. Before model training begins, a client sends first identity information of a labeled sample and second identity information of a client to a server. The server constructs a mapping relationship between the first identity information sent by the client and the second identity information of the client, and counts a number of occurrences of the corresponding labeled sample. The client calculates gradient information of its local labeled sample, and sends the gradient information of its local labeled sample to the server. The server obtains weights of clients corresponding to the same labeled sample based on the gradient information of local labeled samples sent by the clients. Further, the server calculates and obtains target gradient information corresponding to the same labeled sample based on the gradient information, the number of occurrences and the weight of the client of the same labeled sample, and sends the target gradient information to the client to which the same labeled sample belongs. The client updates a local learning model parameter based on the obtained target gradient information, and continues training until the training ends, thereby generating a target federated learning model. In the disclosure, gradient information of labeled samples of a plurality of clients is used as basic sample data for FL-based training, and same labeled samples existing in the plurality of clients are not discarded. Furthermore, fusion calculation and updating of the gradient information of the same labeled samples existing in the plurality of clients are performed, to achieve effective correction of a model training deviation, and further improve the accuracy of model training. Further, data transmission between the server and the client is encrypted to achieve the data confidentiality.

A computer-readable storage medium having a computer program stored thereon is proposed in the embodiments of the disclosure. When the program is executed by the processor 152, the FL-based training method is implemented as described in the above embodiments.

In the computer-readable storage medium stored with a computer program executed by a processor, a computer program stored on the memory 151 is executed by the processor 152. Before model training begins, a client sends first identity information of a labeled sample and second identity information of a client to a server. The server constructs a mapping relationship between the first identity information and the second identity information sent by the client, and counts a number of occurrences of the corresponding labeled sample. The client calculates the gradient information of its local labeled sample, and sends the gradient information of its local labeled sample to the server. The server obtains weights of clients corresponding to the same labeled sample based on the gradient information of local labeled samples sent by the clients. Further, the server calculates and obtains target gradient information corresponding to the same labeled sample based on the gradient information, the number of occurrences and the weight of the client of the same labeled sample, and sends the target gradient information to the client to which the same labeled sample belongs. The client updates a local learning model parameter based on the obtained target gradient information, and continues training until the training ends, thereby generating a target federated learning model. In the disclosure, gradient information of labeled samples of a plurality of clients is used as basic sample data for FL-based training, and same labeled samples existing in the plurality of clients are not dropped, and fusion calculation and updating of the gradient information of the same labeled samples existing in the plurality of clients are performed, to achieve effective correction of a model training deviation, and further improve the accuracy of model training. Further, data transmission between the server and the client is encrypted to achieve the data confidentiality.

Various implementations of systems and technologies described herein may be implemented in a digital electronic circuit system, an integrated circuit system, a field programmable gate array (FPGA), a dedicated application specific integrated circuit (ASIC), a system on a chip (SoC), a load programmable logic device (CPLD), a computer hardware, a firmware, a software, and/or combinations thereof. The various implementations may include: being implemented in one or more computer programs, in which the one or more computer programs may be executed and/or interpreted on a programmable system including at least one programmable processor, and the programmable processor may be a dedicated or a general-purpose programmable processor that may receive data and instructions from a storage system, at least one input device, and at least one output device, and transmit the data and instructions to the storage system, the at least one input device, and the at least one output device.

A computer code configured to execute a method in the disclosure may be written with one or any combination of multiple programming languages. These programming languages may be provided to a processor or a controller of a general purpose computer, a dedicated computer, or other devices for programmable data processing so that the function/operation specified in the flowchart and/or block diagram may be performed when the program code is executed by the processor or controller. The computer code may be executed completely or partly on the machine, executed partly on the machine as an independent software package and executed partly or completely on the remote machine or server.

In the context of the disclosure, a machine-readable medium may be a tangible medium that may contain or store a program intended for use in or in conjunction with an instruction execution system, apparatus, or device. A machine-readable medium may be a machine readable signal medium or a machine readable storage medium. The machine-readable storage medium may include but not limited to an electronic, magnetic, optical, electromagnetic, infrared, or semiconductor system, apparatus or device, or any appropriate combination thereof. A more specific example of a machine readable storage medium includes an electronic connector with one or more cables, a portable computer disk, a hardware, a random access memory (RAM), a read-only memory (ROM), an erasable programmable read-only memory (an EPROM or a flash memory), an optical fiber device, and a portable optical disk read-only memory (CDROM), an optical storage device, a magnetic storage device, or any appropriate combination of the above.

In order to provide an interaction with the user, the systems and technologies described here may be implemented on a computer. The computer has: a display device for displaying information to the user (for example, a cathode ray tube (CRT) or a liquid crystal display (LCD) monitor); and a keyboard and a pointing device (for example, a mouse or a trackball) through which the user may provide input to the computer. Other types of devices may further be configured to provide interaction with the user. For example, the feedback provided to the user may be any form of sensing feedback (for example, a visual feedback, an auditory feedback, or a tactile feedback), and the input from the user may be received in any form (including an acoustic input, a speech input, or a tactile input).

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation of the system and technology described herein), or a computing system including any combination of such back-end components, middleware components or front-end components. The system components may be connected to each other through any form or medium of digital data communication (for example, a communication network). Examples of communication networks include: a local area network (LAN), a wide area network (WAN), an internet and a blockchain network.

The computer system may include a client and a server. The client and server are generally far away from each other and generally interact with each other through a communication network. The relation between the client and the server is generated by computer programs that run on the corresponding computer and have a client-server relationship with each other. The server may be a cloud server, also known as a cloud computing server or a cloud host, which is a host product in a cloud computing service system, to solve the shortcomings of large management difficulty and weak business expansibility existed in the conventional physical host and virtual private server (VPS) service. The server may also be a server with a distributed system, or a server in combination with a blockchain.

In descriptions of the specification, descriptions with reference to the terms “an embodiment”, “some embodiments”, “an example”, “a specific example” or “some examples” etc. mean specific features, structures, materials or characteristics described in conjunction with the embodiments or examples are included in at least one embodiment or example of the disclosure. In this specification, the schematic representations of the above terms do not have to be the same embodiment or example. Moreover, specific features, structures, materials or characteristics described may be combined in any one or more embodiments or examples in a suitable manner. In addition, those skilled in the art may combine different embodiments or examples and characteristics of different embodiments or examples described in this specification without contradicting each other.

In addition, the terms “first” and “second” used in the disclosure are only for description purpose, and may not be understood as an indication or implication to the relative importance, or implicit indication to a number of technical features. Therefore, the features limited with the terms “first” and “second” may explicitly or implicitly include at least one of the features. In the description of the disclosure, “a plurality of” means at least two, for example two, three, etc., unless otherwise specified.

Any process or method descriptions described in the flowchart or in other ways herein may be understood as a module, a segment or a part of codes including one or more executable instructions configured to implement the steps of customized logical functions or processes. The scope of the embodiments of the disclosure include additional implementations, where the functions are implemented in an order not shown or discussed, including a substantially simultaneous manner according to the involved functions or a reverse order, which should be understood by those skilled in the art to which the embodiments of the disclosure belong.

The logic and/or steps represented in the flowchart or described in other ways herein, for example, may be considered as an ordered list of executable instructions configured to implement logic functions, which may be specifically implemented in any computer readable medium, for use by an instruction execution system, an apparatus or a device (such as a computer-based system, a system including a processor, or other systems that may obtain and execute instructions from an instruction execution system, an apparatus or a device), or in combination with the instruction execution system, apparatus or device. The “computer readable medium” in this specification may be any apparatus that may contain, store, communicate, propagate or transmit a program for use by the instruction execution system, apparatus or device or in combination with the instruction execution system, apparatus or device. A more specific example of a computer readable medium (a non-exhaustive list) includes the followings: an electronic connector (an electronic device) with one or more cables, a portable computer disk box (a magnetic device), a random access memory (RAM), a read-only memory (ROM), an erasable programmable read-only memory (an EPROM or a flash memory), an optical fiber device, and a portable optical disk read-only memory (CDROM). In addition, the computer readable medium may even be a paper or other suitable medium on which a program may be printed, since the paper or other medium may be optically scanned, then edited, interpreted or processed in other suitable ways if necessary to obtain the program electronically and store the program in a computer memory.

It should be understood that all parts of the disclosure may be implemented with a hardware, a software, a firmware and their combination. In the above implementation, multiple steps or methods may be stored in a memory and implemented in a software or a firmware executed by a suitable instruction execution system. For example, if implemented in a hardware, they may be implemented by any of the following techniques or their combination known in the art just like in another implementation: a discrete logic circuit with logic gate circuits configured to achieve logic functions for data signals, a special integrated circuit with appropriate combined logic gate circuits, a programmable gate array (PGA), a field programmable gate array (FPGA), etc.

Those skilled in the art may understand that all or part of steps in the above embodiments may be implemented by a program to instruct relevant hardware, in which the program may be stored in the computer readable storage medium. When the problem is executed, one of or a combination of steps in the embodiments of the method is implemented.

In addition, functional units in the embodiments of the disclosure may be integrated in a processing module, or may be physically existed separately, or two or more units may be integrated in a module. The above integrated module may be implemented in the form of a hardware or in the form of a software functional module. The integrated module may be stored in a computer readable storage medium when it is implemented in the form of the software functional module and sold and used as an independent product.

The foregoing storage medium may be a ROM, a magnetic disk or a compact disc, etc. It should be understood that, although the embodiments of the disclosure are shown and described above, the above embodiments are exemplary and cannot be construed as a limitation to the disclosure. Those skilled in the art may change, modify, substitute and vary the above embodiments within the scope of the disclosure.

It should be understood that, the steps in various forms of procedures shown above may be configured to be reordered, added or deleted. For example, the steps described in the disclosure may be executed in parallel, sequentially, or in a different order, as long as the desired result of the technical solution disclosed in the disclosure may be achieved, which may not be limited herein.

The above specific implementations do not constitute a limitation on the protection scope of the disclosure. Those skilled in the art should understand that various modifications, combinations, sub-combinations and substitutions may be made according to design requirements and other factors. Any modification, equivalent replacement, improvement, etc., made within the principle of embodiments of the disclosure may be included within the protection scope of the embodiments of the disclosure.

1. A federated learning-based training method, performed by a server, the method comprising:
receiving gradient information of a labeled sample sent by each client;
obtaining, based on the gradient information sent by each client, target gradient information belonging to a same labeled sample;
determining a client to which each labeled sample belongs; and
sending the target gradient information corresponding to the same labeled sample to a client to which the same labeled sample belongs.

2. The method according to claim 1, wherein determining the client to which each labeled sample belongs, comprises:
for any labeled sample, querying a mapping relationship between labeled samples and clients based on first identity information of the any labeled sample, to obtain a client matching the first identity information of the any labeled sample.

3. The method according to claim 2, further comprising:
receiving first identity information of the labeled sample sent by each client before training; and
obtaining first identity information of the same labeled sample, and establishing a mapping relationship between second identity information of clients corresponding to the same labeled sample and the first identity information of the same labeled sample.

4. The method according to claim 1, wherein obtaining the target gradient information belonging to the same labeled sample based on the gradient information sent by each client, comprises:
obtaining weights of clients corresponding to the same labeled sample; and
obtaining the target gradient information by performing a weighted average on the gradient information sent by the clients corresponding to the same labeled sample based on the weights of the clients corresponding to the same labeled sample and a number of occurrences of the same labeled sample.

5. The method according to claim 1, further comprising:
counting a number of occurrences of each labeled sample after receiving first identity information of the labeled sample sent by each client before training.

6. The method according to claim 1, wherein data transmission between the server and each client is encrypted.

7. A federated learning-based training method, performed by a client, the method comprising:
sending gradient information of a labeled sample of the client to a server after each training;
receiving target gradient information of each labeled sample belonging to the client sent by the server; and
obtaining a target federated learning model by updating, based on the target gradient information, a model parameter of a local learning model and performing a next training.

8. The method according to claim 7, further comprising:
sending first identity information of the labeled sample of the client to the server before the training.

9. The method according to claim 7, wherein data transmission between the client and the server is encrypted.

10. (canceled)

11. (canceled)

12. (canceled)

13. (canceled)

14. (canceled)

15. (canceled)

16. (canceled)

17. (canceled)

18. (canceled)

19. An electronic device, comprising:
at least one processor; and
a memory communicatively connected to the at least one processor and stored with instructions executable by the at least one processor,
wherein the at least one processor is caused to:
send gradient information of a labeled sample of the client to a server after each training;
receive target gradient information of each labeled sample belonging to the client sent by the server; and
obtain a target federated learning model by updating, based on the target gradient information, a model parameter of a local learning model and performing a next training.

20. A non-transitory computer-readable storage medium having computer instructions stored thereon, wherein the computer instructions are configured to cause a computer to perform the method of claim 1.

21. (canceled)

22. The electronic device according to claim 19, wherein the at least one processor is caused to: send first identity information of the labeled sample of the client to the server before the training.

23. The electronic device according to claim 22, wherein data transmission between the server and each client is encrypted.

24. The electronic device according to claim 22, wherein the server is configured to query a mapping relationship between labeled samples and clients based on first identity information of any labeled sample, to obtain a client matching the first identity information of the any labeled sample.

25. The electronic device according to claim 24, wherein the mapping relationship is established based on second identity information of clients corresponding to the same labeled sample and first identity information of the same labeled sample.

26. The electronic device according to claim 19, wherein the server is configured to generate the target gradient information of each labeled sample by performing a weighted average on gradient information sent by clients corresponding to the labeled sample based on weights of the clients, and a number of occurrences of the labeled sample.

27. The electronic device according to claim 22, wherein the server is configured to count a number of occurrences of each labeled sample after receiving the first identity information of the labeled sample.
